(19) United States
(12) Patent Application Publication
(10) Pub. No.: US 2026/0045571 A1
(43) Pub. Date: Feb. 12, 2026

(54) SECONDARY BATTERY

(71) Applicant: SK ON CO., LTD., Seoul (KR)

(72) Inventors: Ho Jin HWANG, Daejeon (KR); Young Ha KIM, Daejeon (KR); Sung Hee MIN, Daejeon (KR); Ga Yeong YOO, Daejeon (KR); Min Jae LEE, Daejeon (KR)

(21) Appl. No.: 19/290,357

(22) Filed: Aug. 5, 2025

(30) Foreign Application Priority Data
Aug. 8, 2024 (KR) 10-2024-0106267

(51) Int. Cl. H01M 10/52; H01M 10/42; H01M 50/105; H01M 50/131; H01M 50/178; H01M 50/186

(52) U.S. Cl. CPC H01M 10/52; H01M 10/4235; H01M 50/105; H01M 50/131; H01M 50/178; H01M 50/186; H01M 2200/20

(57) ABSTRACT

Proposed is a secondary battery, including an electrode assembly to which an electrode lead is coupled, a pouch casing including a receiving portion for receiving an electrode assembly and a sealing portion for sealing the receiving portion, an inner pocket disposed on an inner surface of the receiving portion and filled with a functional material, and a piercing member installed in a receiving space of the receiving portion to pierce the inner pocket.

### CROSS REFERENCE TO RELATED APPLICATION

The present application claims priority to Korean Patent Application No. 10-2024-0106267, filed Aug. 8, 2024, the entire contents of which is incorporated herein for all purposes by this reference.

### BACKGROUND OF THE INVENTION

### Field of the Invention

The present disclosure relates to a secondary battery and, more particularly, to a secondary battery including an inner pocket containing a functional material.

### Description of the Related Art

Secondary batteries are batteries which can be repeatedly charged and discharged. With the advancement of information and communication technologies and display technologies, the secondary batteries are widely used as power sources for portable electronic communication devices such as mobile phones and laptops. Additionally, in line with growing concerns about environmental issues, they have also been used as power sources with output characteristics and stability for eco-friendly means of transportation, such as electric vehicles (EVs) and hybrid vehicles (HEVs), which are recognized as alternatives to fossil fuel-powered vehicles.

Depending on the shape of an outer casing in which an electrode assembly is accommodated, the secondary batteries may be classified into a cylinder type, a prismatic type, and a pouch type. Recently, the demand for thin pouch-type secondary batteries has been increasing.

A pouch-type secondary battery includes an electrode assembly, a pouch casing for accommodating the electrode assembly and an electrolyte solution, and electrode leads electrically connected to the electrode assembly and drawn to the outside. In order to seal the electrode assembly and the electrolyte solution inside the pouch casing, a sealing portion is formed along edges of the pouch casing made of an aluminum laminate sheet by a bonding method such as thermal fusion.

As is well known to those skilled in the art, the pouch-type secondary battery can experience swelling when the electrolyte solution decomposes due to various factors such as overcharging, exposure to high temperatures, and internal short circuits. This decomposition can release high-pressure gas, which causes the pouch casing to expand. Such swelling may cause the sealing portion of the pouch casing to peel off and potentially lead to an explosion or ignition of the secondary battery.

In an effort to solve the above problem, as disclosed in Patent Document 1, technological developments are actively underway for secondary batteries in which a separate gas pocket is formed in a sealing portion to accommodate gas generated inside the battery, or which have a venting structure for rapidly discharging gas to the outside. However, conventional secondary batteries are inherently limited in actively transferring or discharging gas due to the internal pressure build-up within a pouch casing.

The foregoing is intended merely to aid in the understanding of the background of the present disclosure, and is not intended to mean that the present disclosure falls within the purview of the related art that is already known to those skilled in the art.

### DOCUMENTS OF RELATED ART

(Patent document 1) Korean Patent No. 10-2099905

### SUMMARY OF THE INVENTION

According to an aspect of the present disclosure, there is provided a secondary battery configured to release a functional material into an interior of a pouch casing upon an increase in internal pressure of the secondary battery.

A secondary battery according to an embodiment of the present disclosure may include: an electrode assembly to which an electrode lead is coupled; a pouch casing including a receiving portion for receiving an electrode assembly and a sealing portion for sealing the receiving portion; an inner pocket disposed on an inner surface of the receiving portion and filled with a functional material; and a piercing member installed in a receiving space of the receiving portion to pierce the inner pocket.

In the present disclosure, the inner pocket may be made of an electrolyte-impermeable material.

In the present disclosure, the inner pocket may be bonded to an inner side of each of corners of the receiving portion facing the electrode lead in a thickness direction.

In the present disclosure, the piercing member may be located at a joint portion between the electrode lead and a plurality of electrode tabs extended from the electrode assembly.

In the present disclosure, the piercing member may further include a fixing member for assisting in mounting the piercing member at a joint portion between a plurality of electrode tabs extended from the electrode assembly and the electrode lead. In the present disclosure, the piercing member may be made of an insulating material.

In the present disclosure, the pouch casing may include an upper pouch and a lower pouch, wherein the pouch casing may be configured such that the receiving portion is formed in at least one or both of the upper pouch and the lower pouch.

In the present disclosure, the functional material may include a gas absorbent. The features and advantages of the present disclosure will be more clearly understood from the following detailed description when taken in conjunction with the accompanying drawings.

The terms and words used in the specification and claims should not be interpreted as being limited to typical meanings or dictionary definitions, but should be interpreted as having meanings and concepts relevant to the technical scope of the present disclosure based on the rule according to which an inventor can appropriately define the concept of the term to describe the best method he or she knows for carrying out the present disclosure.

According to the present disclosure, by adsorbing gases, moisture, etc. generated inside a secondary battery, it is possible to achieve improved stability of the secondary battery.

Additionally, by releasing the functional material into an interior of the secondary battery when the internal pressure of the pouch casing increases, it is possible to suppress volumetric expansion of the secondary battery

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a perspective view illustrating a secondary battery according to an embodiment of the present disclosure;

FIG. 2 is a sectional view schematically illustrating the secondary battery taken along line A-A of FIG. 1;

FIG. 3 is a perspective view illustrating a coupling state of a piercing member;

FIG. 4 is a perspective view illustrating the secondary battery according to the embodiment of the present disclosure, schematically illustrating an expanded state of a pouch casing due to gas generation; and

FIG. 5 is a sectional view illustrating the secondary battery taken along the B-B line of FIG. 4, schematically illustrating a process of releasing a functional material into an interior of the secondary battery upon expansion of the pouch casing.

### DETAILED DESCRIPTION OF THE INVENTION

The terminology used to describe an embodiment of the present disclosure is not intended to limit the present disclosure. As used herein, the singular forms are intended to include the plural forms as well, unless the context clearly indicates otherwise.

As for reference numerals associated with parts in the drawings, the same or similar reference numerals will refer to the same or similar elements throughout different drawings.

Note that the drawings may be schematic or exaggerated to illustrate implementations. The terms “have”, “may have”, “include”, and “may include” as used herein indicate the presence of corresponding features (for example, elements such as numerical values, functions, operations, or parts), and do not preclude the presence of additional features.

Although the terms “one”, “other”, “another”, “first”, “second”, etc. may be used only to distinguish one element from another element, these elements should not be limited by these terms.

Hereinbelow, an exemplary embodiment of the disclosure will be described in detail with reference to accompanying drawings.

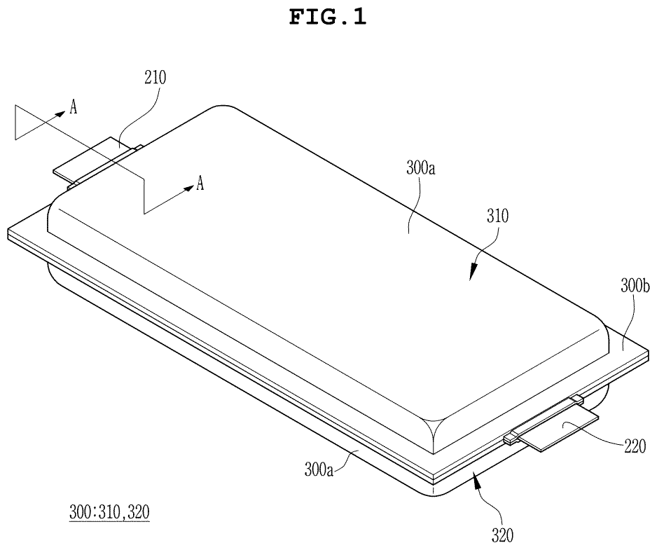

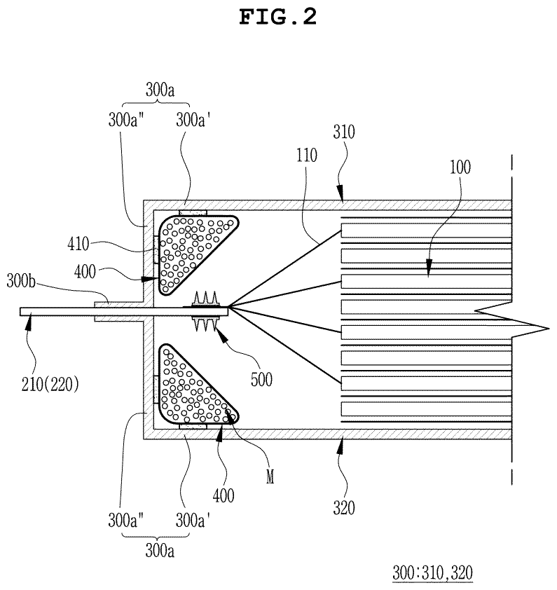

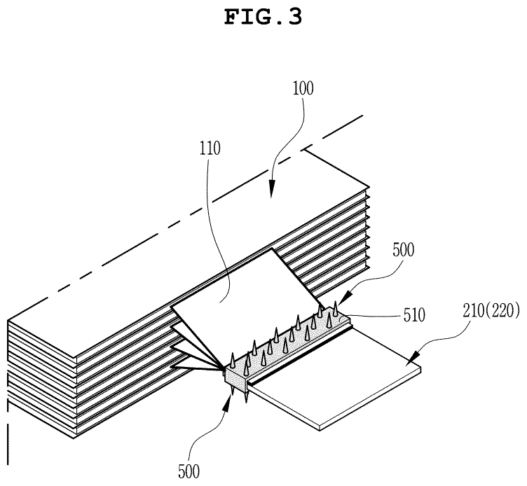

FIG. 1 is a perspective view illustrating a secondary battery according to an embodiment of the present disclosure, and FIG. 2 is a sectional view schematically illustrating the secondary battery taken along line A-A of FIG. 1. Additionally, FIG. 3 is a perspective view illustrating a coupling state of a piercing member.

The present disclosure is configured to suppress a swelling phenomenon of a pouch-type secondary battery, for example, when charging and discharging are excessively repeated or when the internal temperature/internal pressure of the battery abnormally increases.

To this end, the present disclosure includes an electrode assembly 100 to which electrode leads 210 and 220 are coupled, a pouch casing 300 including a receiving portion 300a for receiving the electrode assembly 100 and a sealing portion 300b for sealing the receiving portion 300a, an inner pocket 400 disposed inside the receiving portion 300a and filled with a functional material M, and a piercing member 500 installed in a receiving space of the receiving portion 300a to pierce the inner pocket 400.

In the present disclosure, the electrode assembly 100 may be a jelly-roll type electrode assembly formed by spirally winding a positive electrode plate, a negative electrode plate, and a separator interposed therebetween, or may be a stack-type electrode assembly formed by repeatedly stacking a positive electrode plate, a separator, and a negative electrode plate. Without being limited thereto, the present disclosure is not limited to a specific arrangement as long as an electrode assembly is formed by alternately stacking an electrode plate and a separator to provide a predetermined thickness in a stacking direction (or thickness direction). The electrode lead 210 drawn to the outside of the pouch casing 300 is electrically connected to a positive electrode tab, which is a non-coated portion of a positive electrode plate where no positive electrode active material is applied by, for example, ultrasonic welding. Correspondingly, the electrode lead 220 drawn to the outside of the pouch casing 300 is electrically connected to a negative electrode tab, which is a non-coated portion of a negative electrode plate where no negative electrode active material is applied by, for example, ultrasonic welding. Here, the positive and negative electrode tabs are each referred to as an electrode tab 110.

A free end of each of the electrode leads 210 and 220 is drawn to the outside of the pouch casing 300 through the sealing portion 300b of the pouch casing 300. Of course, the free end of each of the electrode leads 210 and 220 may be connected to another secondary battery or an external device.

Additionally, the present disclosure provides that an insulating film (no reference numeral) is disposed at a contact area between each of the electrode leads 210 and 220 and the sealing portion 300b of each of upper and lower pouches 310 and 320, thereby not only ensuring insulation between the electrode leads 210 and 220 and the pouch casing 300, but also enhancing sealing strength. The insulating film may be attached in a form that surrounds an outer periphery of each of the electrode leads 210 and 220.

In general, the secondary battery has a structure in which the electrode assembly 100 and an electrolyte are sealed and stored in an internal space of the pouch casing 300. As described above, the pouch casing 300 includes the upper pouch 310 that covers an upper side of the electrode assembly 100 and the lower pouch 320 that covers a lower side of the electrode assembly 100 to form the internal space for accommodating the electrolyte together with the electrode assembly 100. The upper pouch 310 and the lower pouch 320 are hermetically sealed together along the edges thereof by thermal fusion to form the sealing portion 300b.

As illustrated in FIG. 2, the pouch casing 300 may have the receiving portion 300a that is located inwards of the sealing portion 300b and provides a receiving space for receiving the electrode assembly 100 and the electrolyte between the upper pouch 310 and the lower pouch 320 that are spaced apart from each other. As is widely known, the pouch casing 300 is subjected to a forming process to form a cup-shaped space for accommodating the electrode assembly 100, i.e., the receiving portion 300a serving as a receiving space. The cup-shaped space may be formed in an internal area of the upper pouch 310 and/or the lower pouch 320 to a predetermined depth. Although the present disclosure describes that the receiving portion 300a is formed in each of the upper pouch 310 and the lower pouch 320, the pouch casing 300 is preferably configured such that the receiving portion 300a is formed in at least one or both of the upper pouch 310 and the lower pouch 320.

As described above, the present disclosure provides that the receiving portion 300a defined by a flat surface 300a′ and side surfaces 300a″ is formed in the internal area of the upper pouch 310 and/or the lower pouch 320. The flat surface 300a′ of the receiving portion 300a may be disposed to face the electrode assembly 100 in parallel, that is, it may be disposed to face the electrode assembly 100 in a thickness direction of the electrode assembly 100. In the specification of the present disclosure, the thickness direction refers to a stacking direction of the electrode assembly 100.

Additionally, the side surfaces 300a″ of the receiving portion 300a may be bent and extended toward the sealing portion 300b around the edges of the flat surface 300a′. Thus, the side surfaces 300a″ may integrally connect the sealing portion 300b and the flat surface 300a′ that have a predetermined height difference, while also providing the receiving portion 300a with a depth corresponding to the height of the side surfaces 300a″.

Furthermore, the edges of the upper pouch 310 and the edges of the lower pouch 320 may be integrally extended around the periphery of the receiving portion 300a and joined to each other to form the sealing portion 300b.

As illustrated in FIG. 2, the pouch casing 300 is formed by interposing the electrode leads 210 and 220 between the edges of the upper pouch 310 and the edges of the lower pouch 320 and thermally fusing the edges to form the sealing portion 300b in a sealed state.

In particular, the present disclosure includes the inner pocket 400 filled with the functional material M inside the pouch casing 300. Here, the functional material M is not particularly limited, but may be one or more materials selected from the group consisting of a gas absorbent, a moisture absorbent, a fire extinguishing agent, a flame retardant, and a stabilizing material, and preferably, may be a gas absorbent.

The present disclosure provides that the inner pocket 400 is filled with the functional material M, specifically a gas absorbent. When the inner pocket 400 is ruptured, the gas absorbent therein is released into the internal space of the pouch casing 300, thereby efficiently absorbing gases (e.g., CO and CO₂) generated inside the secondary battery and ensuring the safety of the secondary battery.

Additionally, the present disclosure provides that the inner pocket 400 is filled with the functional material M, that is, a moisture absorbent. When gas is generated inside the secondary battery, moisture inside the secondary battery may increase. This moisture is known to cause undesirable side reactions inside the secondary battery. Therefore, it is preferable to remove the generated moisture along with the gas by using the moisture absorbent.

Additionally, the present disclosure provides that the inner pocket 400 is filled with a fire extinguishing agent for extinguishing a fire occurring inside the secondary battery, a flame retardant for preventing ignition caused by heat generation, a heat stabilizing material for suppressing battery ignition, or a lithium stabilizing material for stabilizing lithium deposited on the surface of a negative electrode to prevent explosive reactions of lithium.

The present disclosure provides that the inner pocket 400 is disposed inside the receiving portion 300a of the upper pouch 310 and/or the lower pouch 320. Preferably, the present disclosure provides that the inner pocket 400 is disposed on an inner surface of the receiving portion 300a of the upper pouch 310 and/or the lower pouch 320.

As is widely known, the secondary battery according to the present disclosure is produced by injecting an electrolyte, specifically a liquid electrolyte, into the interior of the pouch casing 300. Accordingly, the inner pocket 400 may be made of an electrolyte-impermeable material to prevent the functional material M from reacting with the electrolyte. Additionally, it is preferable that the inner pocket 400 is made of a hydrophobic and liquid electrolyte-impermeable material.

Furthermore, the present disclosure provides that the functional material M inside the inner pocket 400 is released into an interior of the receiving portion 300a of the pouch casing 300 by rupturing the inner pocket 400. The present disclosure provides that the position of the inner pocket 400 is fixed inside the receiving portion 300a so that the inner pocket 400 can be instantaneously pierced or ruptured upon swelling of the secondary battery. For example, the secondary battery according to the embodiment of the present disclosure may be configured such that the inner pocket 400 is attached to the inner surface of the receiving portion 300a via an adhesive 410. More specifically, the inner pocket 400 may be bonded to an inner side of each of corners of the receiving portion 300a facing the electrode leads 210 and 220. That is, the inner pockets 400 may be disposed and coupled to the inner sides of the corners surrounded by the flat surface 300a′ and the side surfaces 300a″ of the receiving portion 300a facing the electrode leads 210 and 220 in the thickness direction, so when the secondary battery is at normal temperature and pressure, the inner pockets 400 and the electrode leads 210 and 220 may be arranged to be spaced apart from each other.

The secondary battery according to the embodiment of the present disclosure includes the piercing member 500 that pierces the inner pocket 400.

The piercing member 500 may be disposed at a position corresponding to the inner pocket 400 so as to make contact with the inner pocket 400 when swelling occurs in the secondary battery, and may be supported at a joint portion between a plurality of electrode tabs 110 extended from the electrode assembly 100 and each of the electrode leads 210 and 220. Without being limited thereto, the piercing member 500 may be fixed in position at a fixed end of each of the electrode leads 210 and 220 joined to the electrode tabs 110, or at a location adjacent to the fixed end.

As described above, a base portion of the piercing member 500 is fixed at the joint portion between the electrode tabs 110 and each of the electrode leads 210 and 220, while a tip portion of the piercing member 500 is extended in the thickness direction of the electrode assembly 100 toward the inner pocket 400. The present disclosure provides that, under normal conditions, the length of the piercing member 500 is shorter than the distance in the thickness direction between each of the electrode leads 210 and 220 and the flat surface 300a′ of the receiving portion 300a, or shorter than the distance between each of the electrode leads 210 and 220 and the inner pocket 400 in order to prevent unnecessary contact between the piercing member 500 and the inner pocket 400.

Furthermore, the piercing member 500 may further include a fixing member 510 that assists in mounting the piercing member 500 at the joint portion between the electrode tabs 110 extended from the electrode assembly 100 and each of the electrode leads 210 and 220. The fixing member 510 may be an adhesive, a bonding tape, or a band capable of fixing the position of the piercing member 500, but is not limited thereto and may be any configuration that can fix the piercing member 500.

Additionally, it is preferable that the piercing member 500 is made of an insulating material. By employing the piercing member 500 made of the insulating material, the present disclosure may prevent unexpected electrical connection between the electrode leads 210 and 220 and the pouch casing 300, thereby preventing short circuits, swelling, and the like.

A method of releasing the functional material into an interior of the secondary battery according to the embodiment of the present disclosure having the above-described configuration will be described as follows.

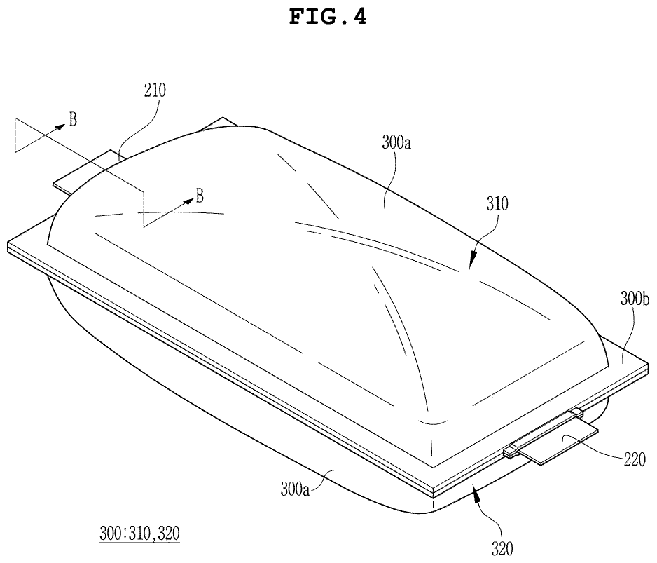

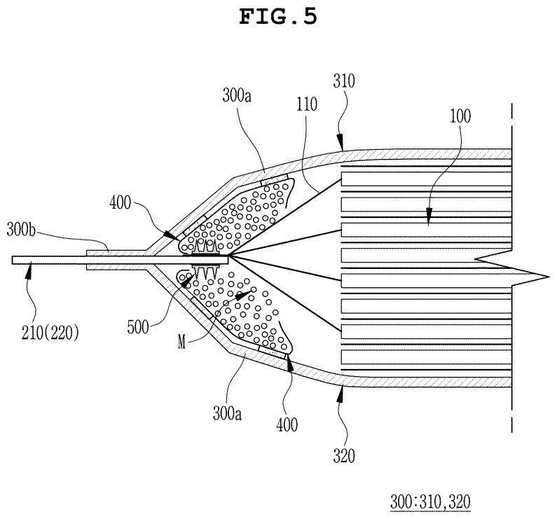

FIG. 4 is a perspective view illustrating the secondary battery according to the embodiment of the present disclosure, schematically illustrating an expanded state of the pouch casing 300 due to gas generation. FIG. 5 is a sectional view illustrating the secondary battery taken along the B-B line of FIG. 4, schematically illustrating a process of releasing the functional material into the interior of the secondary battery upon expansion of the pouch casing.

As described above, when the temperature and pressure inside the pouch casing 300 increase due to overcharging, internal short circuits, etc., it causes a swelling phenomenon in which the pouch casing 300 expands. For example, a large amount of gas generated inside the secondary battery pressurizes the pouch casing 300 outwards. As the gas pressure increases, it causes deformation such as a part of the pouch casing 300 bulging outwards.

Since the sealing portion 300b joined along the edges of the upper pouch 310 and the lower pouch 320 is formed along the outer periphery of the pouch casing 300, a central portion of the pouch casing 300 that is spaced apart from the sealing portion 300b located at the outer periphery of the pouch casing 300 expands more than other areas, resembling a balloon. In other words, a central portion of the receiving portion 300a expands and bulges, while a peripheral portion thereof adjacent to the sealing portion 300b expands and deforms less severely. Thus, as the pouch casing 300 expands in volume due to the gas pressure, the corners of the receiving portion 300a become stretched.

As illustrated in FIGS. 4 and 5, when swelling occurs, the pouch casing 300 is deformed to a streamlined shape that becomes narrower from the central portion of the receiving portion 300a toward the sealing portion 300b. This causes the inner pocket 400 to come into close proximity with the piercing member 500, resulting in contact between the inner pocket 400 and the piercing member 500. Additionally, the piercing member 500 may be supported by the electrode leads 210 and 220, allowing it to remain securely fixed in position even when the pouch casing 300 expands in volume.

The present disclosure allows the functional material M, such as a gas absorbent, filled in the inner pocket 400, to be released into the interior of the receiving portion 300a of the pouch casing 300 by cutting (or piercing) the inner pocket 400 using the piercing member 500.

The gas absorbent released in this manner efficiently absorbs gas generated inside the secondary battery, thereby preventing deformation of the pouch casing and/or the electrode assembly and suppressing degradation in the performance of the secondary battery.

Hereinabove, the present disclosure has been described in detail with reference to a specific embodiment. The embodiment is intended to illustrate the present disclosure in detail, and the present disclosure is not limited thereto. It will be apparent to those skilled in the art that modifications thereto or improvements thereof are possible within the technical spirit of the present disclosure.

All simple modifications and alterations of the present disclosure fall within the scope of the present disclosure, and the specific protection scope of the present disclosure will be clearly defined by the appended claims.

What is claimed is:

1. A secondary battery, comprising:
an electrode assembly to which an electrode lead is coupled;
a pouch casing including a receiving portion for receiving an electrode assembly and a sealing portion for sealing the receiving portion;
an inner pocket disposed on an inner surface of the receiving portion and filled with a functional material; and
a piercing member installed in a receiving space of the receiving portion to pierce the inner pocket.

2. The secondary battery of claim 1, wherein the inner pocket is made of an electrolyte-impermeable material.

3. The secondary battery of claim 1, wherein the inner pocket is bonded to an inner side of each of corners of the receiving portion facing the electrode lead in a thickness direction.

4. The secondary battery of claim 1, wherein the piercing member is located at a joint portion between the electrode lead and a plurality of electrode tabs extended from the electrode assembly.

5. The secondary battery of claim 1, wherein the piercing member further includes a fixing member for assisting in mounting the piercing member at a joint portion between a plurality of electrode tabs extended from the electrode assembly and the electrode lead.

6. The secondary battery of claim 1, wherein the piercing member is made of an insulating material.

7. The secondary battery of claim 1, wherein the pouch casing includes an upper pouch and a lower pouch, wherein the pouch casing is configured such that the receiving portion is formed in at least one or both of the upper pouch and the lower pouch.

8. The secondary battery of claim 1, wherein the functional material includes a gas absorbent.
